(19) United States
(12) Patent Application Publication
(10) Pub. No.: US 2013/0067582 A1
(43) Pub. Date: Mar. 14, 2013

(54) SYSTEMS, METHODS AND DEVICES FOR PROVIDING DEVICE AUTHENTICATION, MITIGATION AND RISK ANALYSIS IN THE INTERNET AND CLOUD

(71) Applicants: John Joseph Donovan, Hamilton, MA (US); Paul David Parisi, Boxford, MA (US); Svetlana I. Dotsenko, Beverly, MA (US)

(72) Inventors: John Joseph Donovan, Hamilton, MA (US); Paul David Parisi, Boxford, MA (US); Svetlana I. Dotsenko, Beverly, MA (US)

(21) Appl. No.: 13/291,651

(22) Filed: Nov. 8, 2011

Related U.S. Application Data
(60) Provisional application No. 61/413,190, filed on Nov. 12, 2010.

(51) Int. Cl. G06F 21/00

(52) U.S. Cl. 726/25

(57) ABSTRACT

The present invention is a method to provide mechanisms and judgment to determine the ongoing veracity of “purported” devices (sometimes called spoofing) with such parameters as unique device ID, access history, paths taken and other environmental data (Device Authentication).

This invention relies upon a previous invention “Reputation Database in the cloud and Internet”—the internet is comprised of collections of devices, data, applications and networks all dynamically exchanging information among users. We present a mechanism for real time observation, and putting or accessing those observations into a distributed virtual database for contextual evaluation and analysis of how the internet is being used or potentially subverted. This includes real time evaluation of DNS database changes, server logs, performance, path resolution, device logs, tip data and law enforcement data.

This invention is particularly useful for helping detect and mitigate data compromises, networks, systems and other assets within the internet.

### FIELD OF THE INVENTION

The present invention is generally related to the security, reputation, and integrity of the internet and the cloud. More specifically, this invention relates to a system, method, and apparatus for detecting compromise of devices and real-time information all of which make-up the internet portion of the cloud. The present invention may be used to fight vulnerabilities of data, applications, devices, and other assets in the cloud and the internet.

### BACKGROUND OF THE INVENTION

The evolution of deploying applications, servers, and assets has gone from a mainframe environment to a client/server environment to an internet environment and now to the cloud. And further with the explosion of devices and the decentralization of intelligence in those devices has made the integrity of the entire internet vulnerable to any compromise in those devices. With this trend manufactures such as IBM have introduced entire initiatives, such as Smarter Planet, to take advantage of these intelligent devices. This has been driven by the economics of a return-on-investment that has been gained by sharing applications, infrastructure, the substantial reduction of prices of devices, increased usage, and sophisticated applications on these devices and the internet. And the gradual shift of what were strategic applications such as inventory automation to being a commodity. These commodity applications are necessary but do not need to be proprietary hence can be shared in the cloud.

IT professionals and business personnel have elected to use the cloud to host their applications and access them through the internet. Twenty percent of all enterprise applications are hosted in either a private or the public cloud. Early adopters are now running 60 to 70% of business applications in the cloud. See http://www.marketwire.com/press-release/Early-Adopters-Now-Running-60-to-70-Percent-of-Business-Applications-in-the-Cloud-1328179.htm.

This cloud market is estimated at $50B and growing at 20% annually. However, this eclectic set of technologies comprised in the cloud and internet access has led to massive vulnerabilities in management and security.

For example known vulnerabilities have been reported in the literature:

Cloud Insecurity—Sharing the Cloud with Your Enemy http://www.slideshare.net/ilpropheta/cloud-insecurity.

For example:

Texas insider sentenced to 15 years for medical ID theft—Oct. 19, 2010 http://www.scmagazineus.com/texas-insider-sentenced-to-15-years-for-medical-id-theft/article/181255/.

“Medical identity theft has been on the upswing for the past few years, in part because of the wealth of personal information available in medical records, experts have said. Thieves can use this information to obtain medical treatment or prescription drugs that they otherwise would not have had access to. Medical records include not only names and addresses, but also employer and financial account information, which makes it profitable, according to experts. Also, within the health care sector, patient information is often shared with other doctors, insurance companies and other health care facilities. According to a Ponemon Institute study released in early March, nearly 1.5 million Americans have suffered from medical identity theft. It is estimated the cost associated with medical identity theft totals $29 billion, or approximately $20,000 per victim.”

The validation embodiment of this invention specifically addresses this vulnerability by knowing who has accessed a device and how it may have been manipulated.

For example:

“A high-tech tip, an old-school stakeout in Craigslist attacks” The Boston Globe, Apr. 23, 2009. http://www.boston.com/news/local/massachusetts/articles/2009/04/23/a_high_tech_tip_an_old_school_stakeout/

“A computer identification code known as an IP address was the first clue to draw police to the luxury towers in Quincy, where Markoff lived in a $1,400-a-month one-bedroom apartment.” This invention would go much further using not only the IP address, but also the entire environment including network paths, log files, location information, telephone records to not only identify the computer involved but the user, location, access history, other sites visited/targets and correspondence as well.

### BRIEF SUMMARY OF THE INVENTION

One embodiment of the present invention is a method for giving situational awareness and alerting on the following conditions: Device Authentication—provide a mechanism and judgment to determine the ongoing veracity of the “purported” device with such parameters as unique device ID, history of access, paths taken and other environmental data.

### BRIEF DESCRIPTION OF THE DRAWINGS

FIG. 1 illustrates a systems architecture for situational awareness of assets in the cloud, including the data center (traditional storage devices, processes, email devices), traditional network management capabilities (security, performance, monitoring; e.g. Tivoli), users accessing their services in the cloud via the internet. The lower part of FIG. 1 depicts the focus of this patent. Network access points, network paths, connected devices and gateways are all represented by devices. These devices can be observed and contextualized to understand potential anomalies.

FIG. 2—illustrates the device parameters that may be used to authenticate a device.

FIG. 3—depicting example data populating the reputation database.

FIG. 4—depicts an example alert notification of a compromise that has occurred with an accounting application and the automatic actions taken.

FIG. 5—depicts an example of the relationship between the applications and observed risks, the larger the circle the higher the risk.

FIG. 6—depicts an example of mitigation and reports sent compromise in an accounting application.

FIG. 7—depicts an example of threshold risk analysis of an intrusion.

FIG. 8—depicts an example dashboard for contextualized situational awareness.

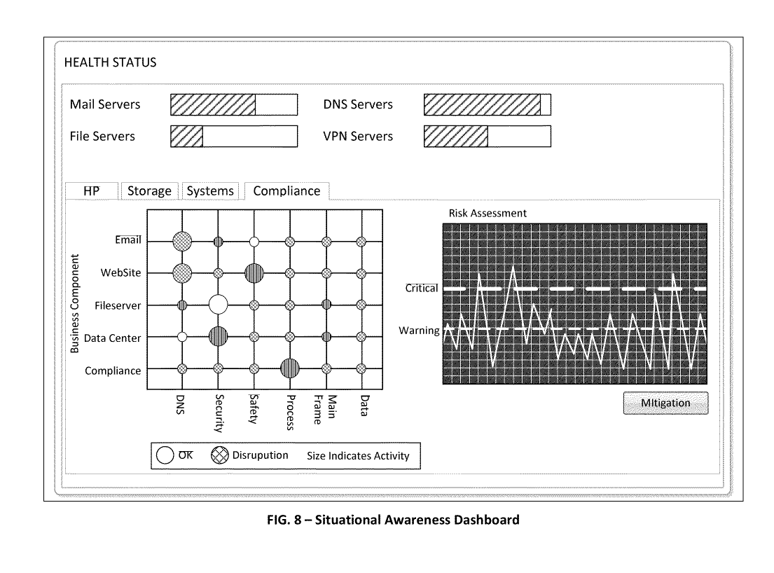

FIG. 9—depicts a risk analysis of compounded event such as change in reputation data involving email blacklisting and paths.

FIG. 10—depicts an example risk analysis of data center breach correlating physical intrusion detection, log file changes, DNS changes, etc.

FIG. 11—example of mitigation alerting to a security breach and physical configuration of a facility.

FIG. 12—example of an escalation of alert for a security breach whereby if no response to mitigation takes place an orderly notification of other possible mitigation mechanisms takes place.

FIG. 13—example of a presentation layer on an Apple iPhone device. Figure X—an example of the storage of device information observed over time.

FIG. 14—example of an automatic, customizable, forensic analysis of alerted situation.

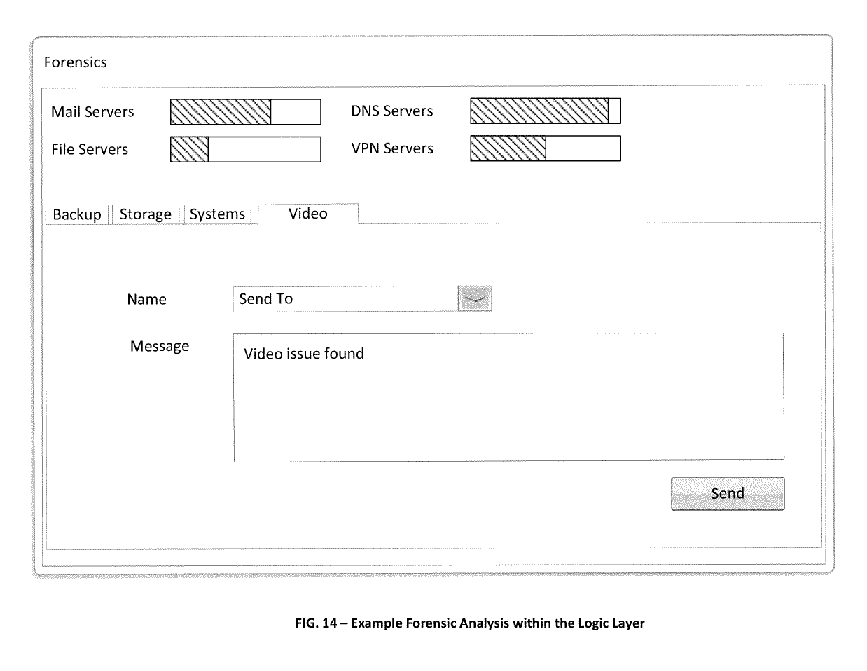

FIG. 15—example of three-tier implementation architecture for analysis/correlation, alert engine, authentication and reputation database components.

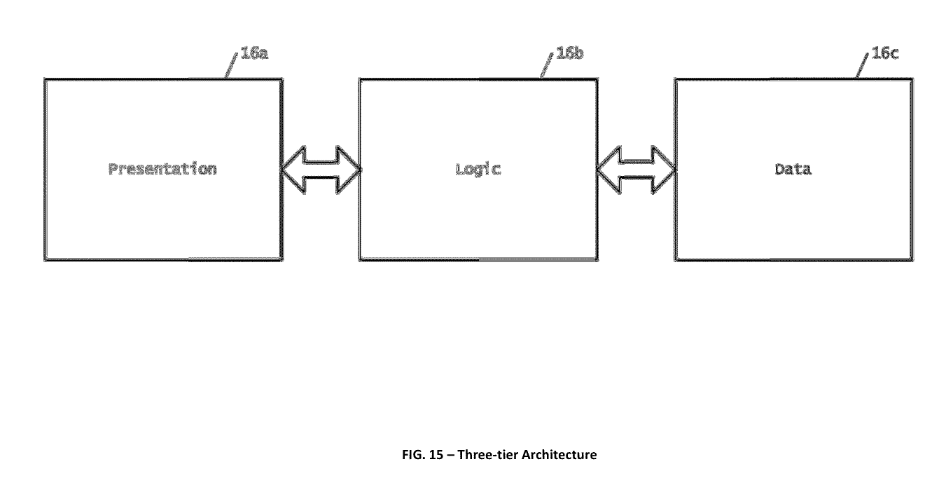

FIG. 16—example of set theoretical view of the analysis.

### DETAILED DESCRIPTION OF THE INVENTION

The present invention provides a system, a method, and an apparatus for situational awareness of devices, including devices, which comprise the internet, networks and cloud infrastructure.

Definitions

“Cloud”—from the viewpoint of the user it is a general utility that handles all user applications, software and hardware needs. The user may be charged by the transaction.

“Hosting” from the viewpoint of the hosting provider is a collection of servers, mainframes, storage units, the internet, all of the hardware and software to host multiple applications

“Hardware/Software vendors” form the point of view the cloud is a new and changing market for hardware, software and consulting services, as cloud adoption grows need for self-fielded equipment will decline and need for hardware for the cloud service providers will increase.

“DNS (Domain Name System)” is one of the largest databases in the world consisting of the information needed to traverse the pathways to devices and assets on the internet.

As used herein, the term “meta-data” shall designate data about data. Examples of meta-data include primitive events, (including changes in DNS, network paths, device identification), compound events, meta-data extracted from independent tips, network events, device information, and external information provided by government and law enforcement and other consortium. Meta-data also includes compound events and correlated events, defined below. Meta-data also includes information added manually by a human reviewer, such as a person who reviews tips and reports.

“Primitive events” may be generated automatically by various devices, or may be generated in software based on data from various databases. In one embodiment, a human operator adds meta-data and thereby generates primitive events. For example, a human operator may add meta-data indicating, “suspicious activity was observed at this location which houses servers.”

As used herein, “correlated events” shall include primitive and/or compound events that have been correlated across either data, devices, meta-data, servers, space or time. An example of a correlated event is a change in or of device (including IP device) attributes.

As used herein, the term “attribute data” shall designate data about devices or sources (such as DNS data), such as the quality of the data produced by the devices, the age of the devices or data, time since the devices or data were last maintained, integrity of the devices or data, reliability of the devices or data, and so on. Attribute data has associated weights.

In the case of tips, attribute data refers to data about the source of the tips. For example, a tip from an anonymous submitter will have different weights corresponding to the attribute data than a tip submitted by a law enforcement officer.

Contextual attribute data is stored and corresponds to the attribute data of the device that captured the data. For example, the meta-data is stored with memorialization of the same context of that data and meta-data.

“Meta-data” (primitive events, compound events, correlated events, etc.) and attribute data are used throughout the present invention. Meta-data in the form of primitive events is used to detect compound events of higher value. Primitive and compound events are correlated across space and time to generate additional meta-data of even higher value. The events are weighted according to the attribute data corresponding to the devices that generated the events. Primitive, compound, and correlated events may trigger one or more intelligent alerts to one or more destinations. The meta-data is also used for forensic analysis to search and retrieve data by event.

Meta-data and attribute data are both used for event correlation, for network management, and detection of vulnerabilities.

Finally, the analysis of a set of correlated events may lead to “resetting” (flip flop) of the entire decision tree that led to the alert.

Systems Architecture

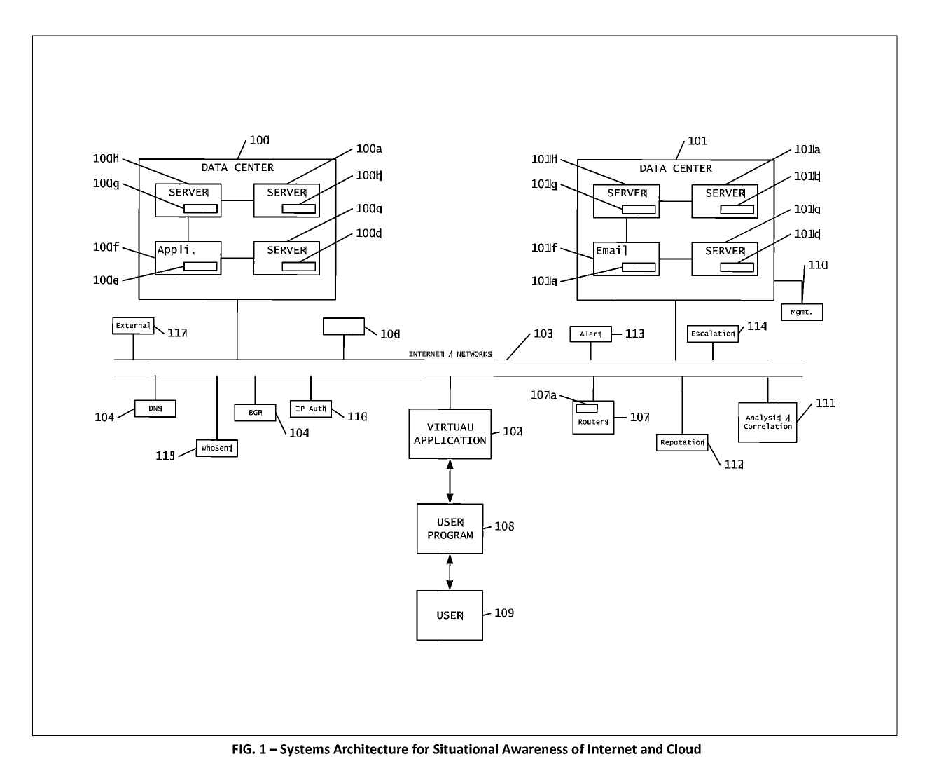

One embodiment of the present invention is a system, a method, and an apparatus for data surveillance, vulnerabilities detection and alerting in a cloud environment. FIG. 1 shows an example of a system architecture of one embodiment of the present invention related to a cloud and internet. Data centers 100 and 101 house collections of computers (100a, 100c, 100h, 101a, 101c and 101h) and other resources (100f and 101f) they are managed by traditional network management software (110) (e.g. HP Openview). These data centers are accessible via the network (103), internet (103) and the required infrastructure (100f and 101f) to support the activity of the virtual applications (102) (e.g. SalesForce.com) provided by such equipment. Additionally the health, status, and network (103) connectivity of all components and subsystems/infrastructure (104, 105, 106 and 107) of the connected systems are stored in logs (100b, 100d, 100g, 101b, 101d, 101g and 107a). Systems are hosted including virtual applications (102), user programs (108) and users (109). For example, a user opens a web browser and accesses an application running in virtual datacenters. Data traverses systems and paths and this activity can be observed and memorialized for normalization and comparison and action (111, 112, 113, 114, 115 and 116).

The alert engine (113) is triggered by the analysis (111) engine analyzing the device (including IP devices) attributes. The escalation engine (114) has dynamic and customizable rules activated by all data sources. The management tools (110) are traditional tools that produce independent reports on performance, etc. and provide data to the analytics engine (111) for situational awareness.

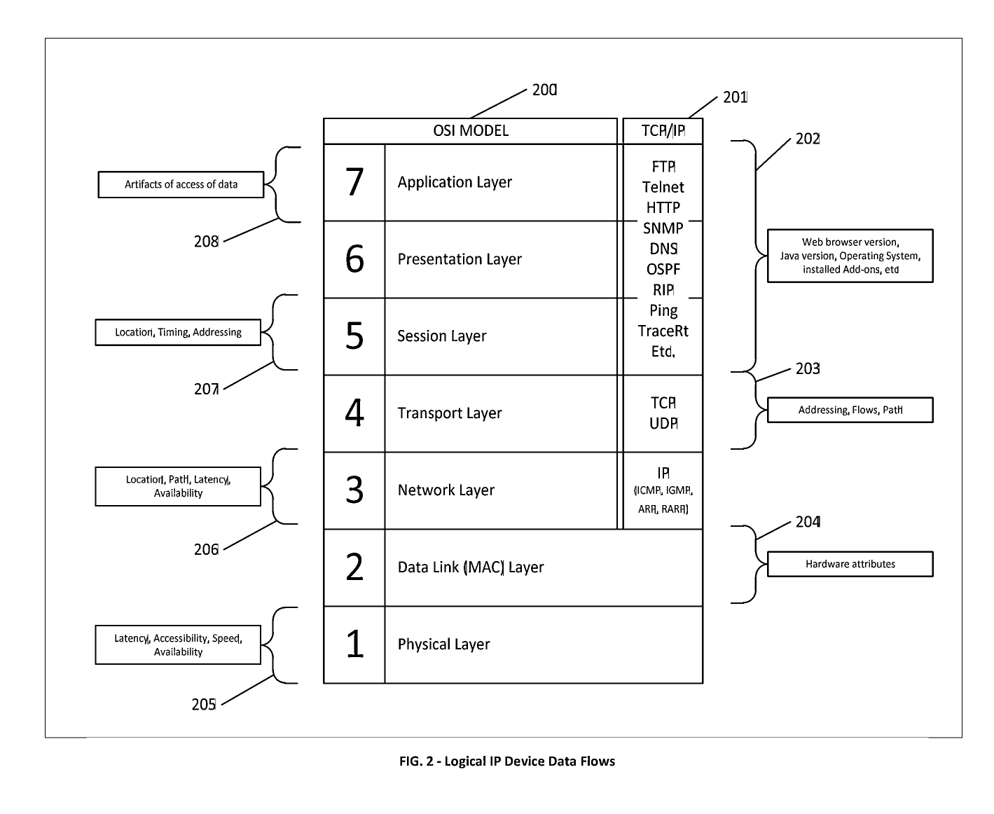

FIG. 2 depicts the architecture (200) for data sources for device data sources for use in authentication (FIG. 1, 116) by the correlation process (111). Primitive events, context and data are expressed (202, 203, 204, 205, 206, 207 and 208). The OSI model (201) is representative of the multiple interfaces available for data gathering.

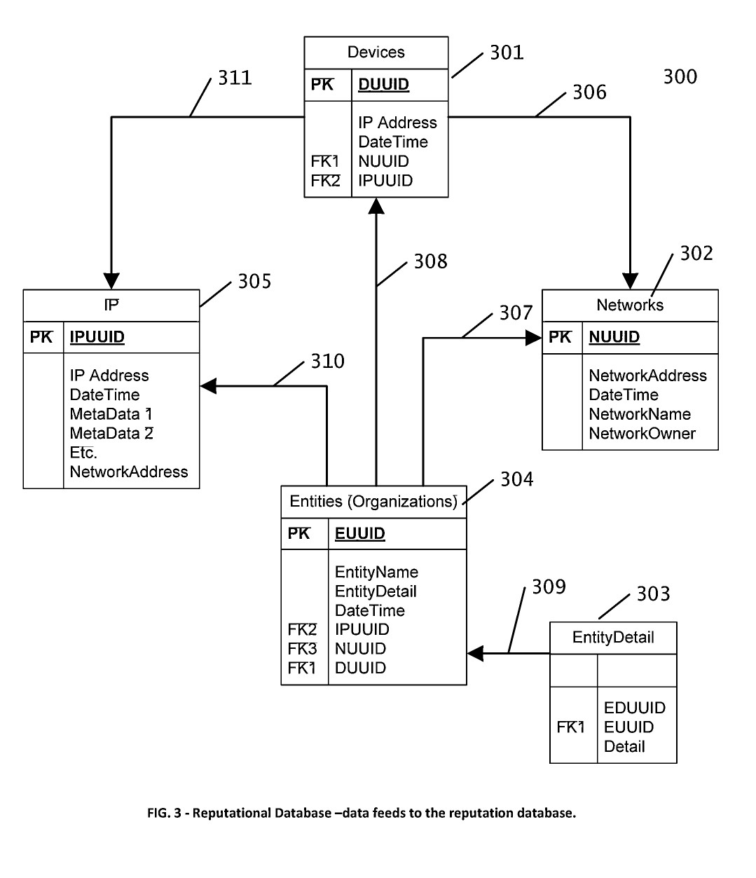

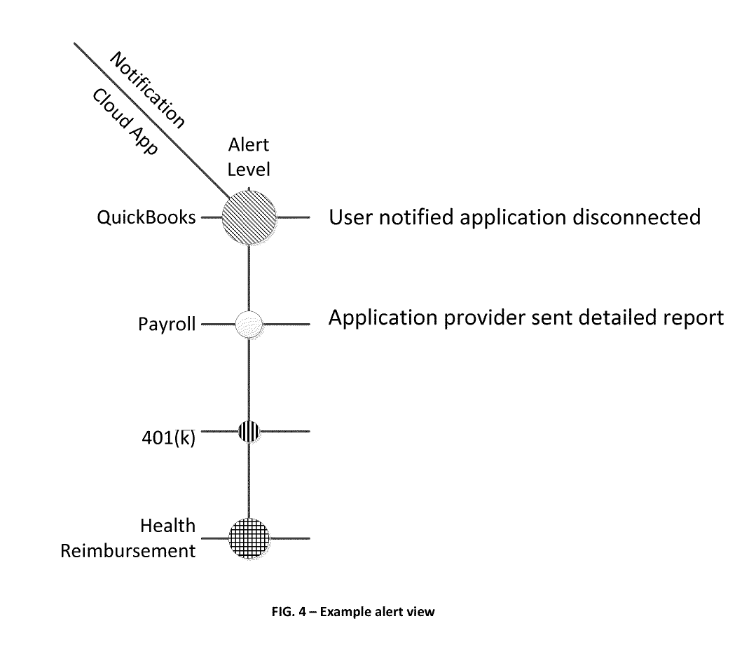

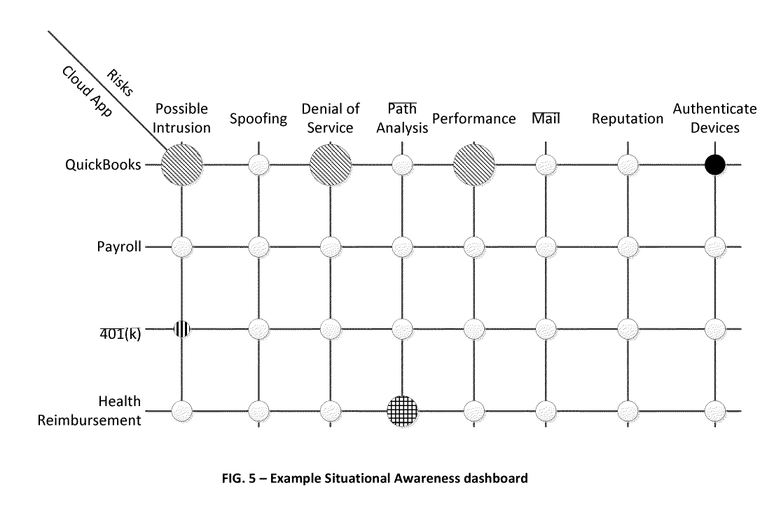

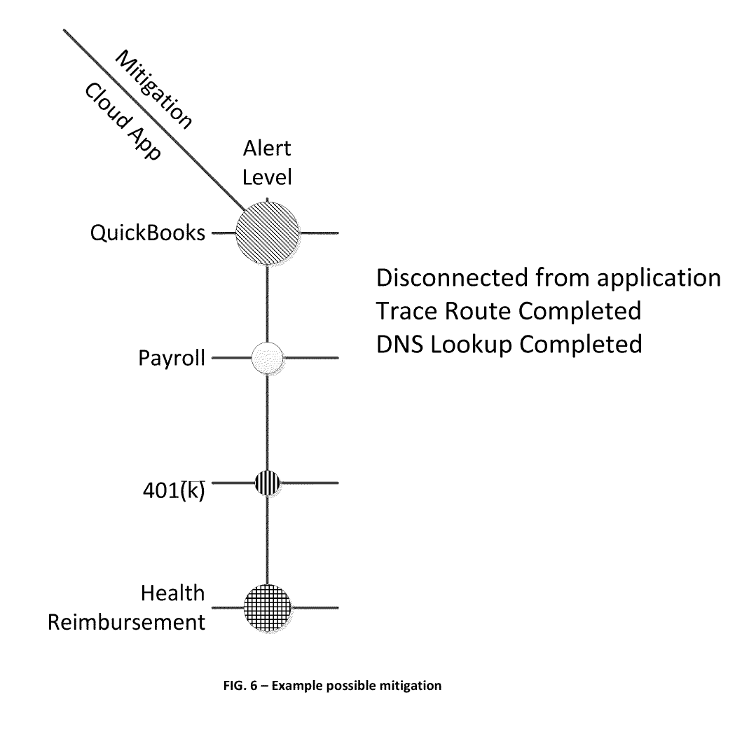

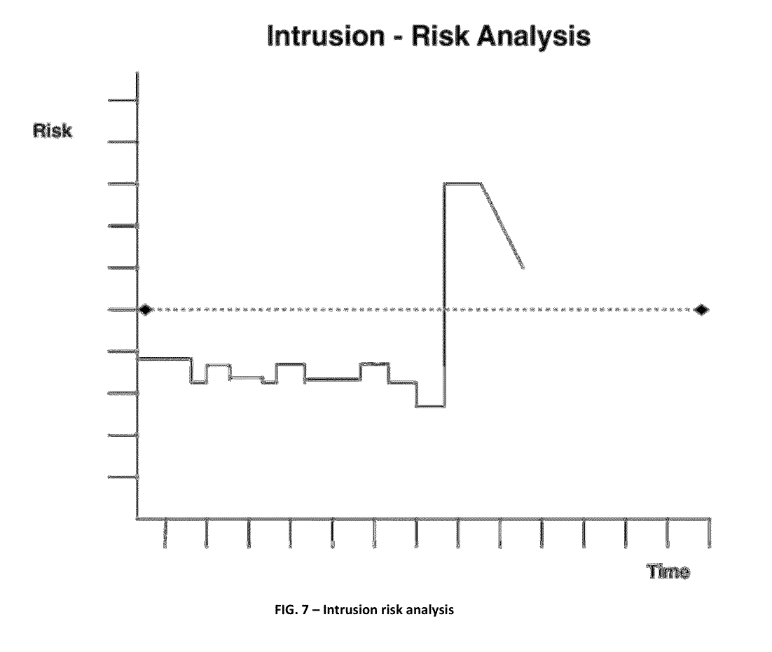

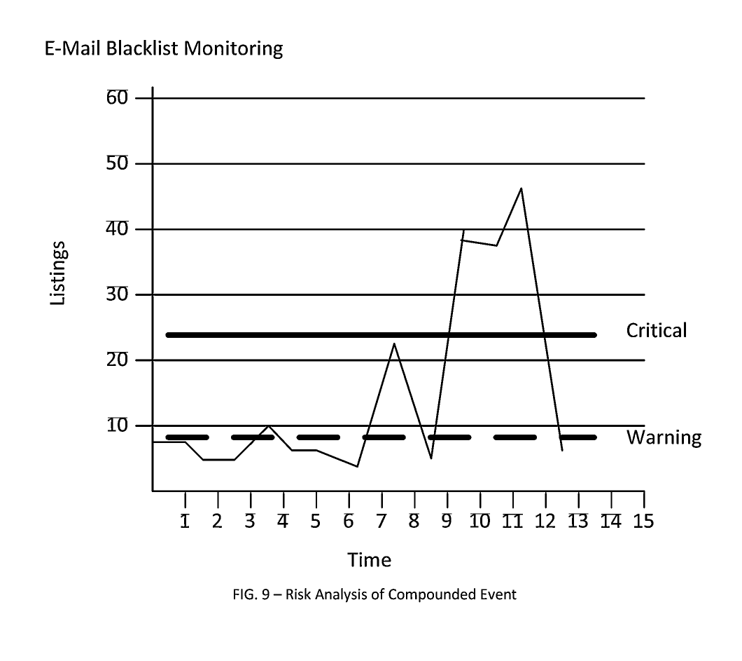

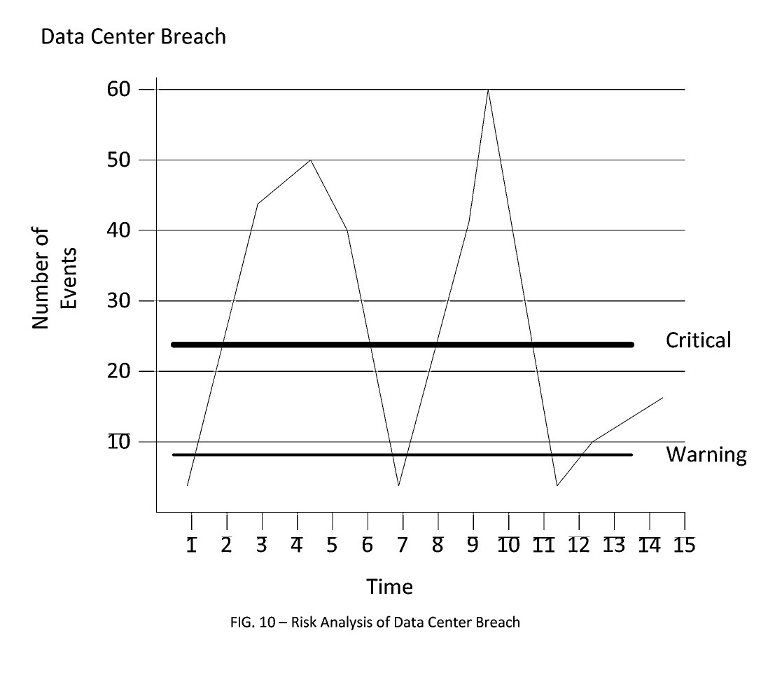

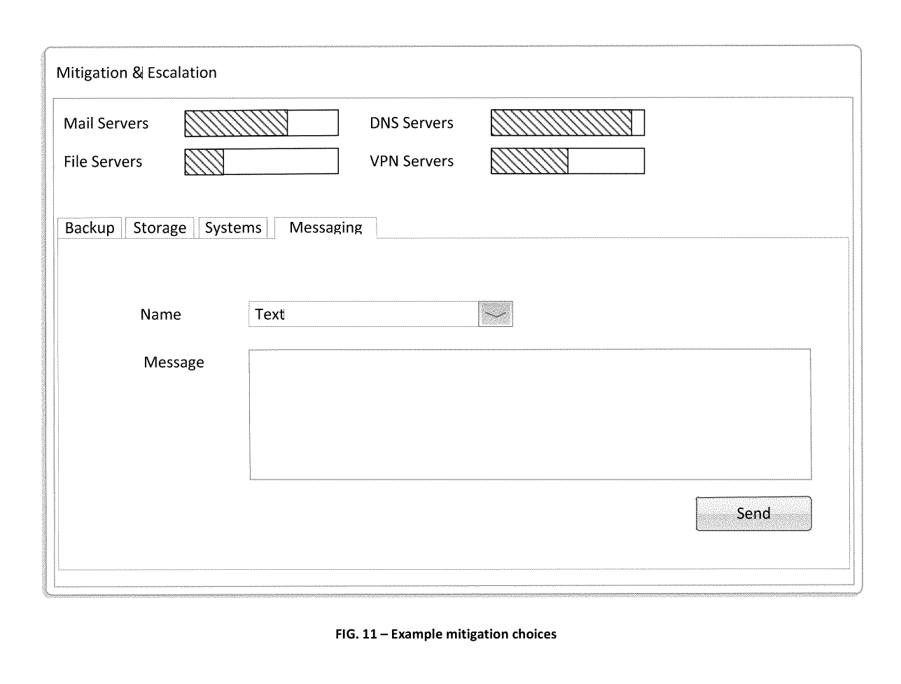

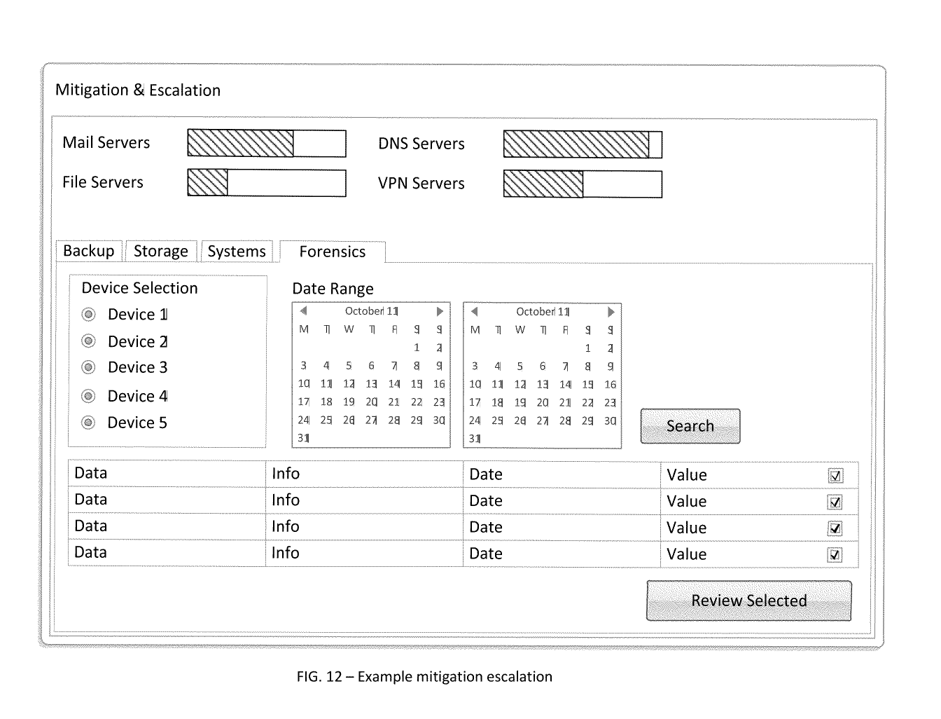

FIG. 3 depicts the common data storage model (300) for the correlation of data available in FIG. 1 (112) and FIG. 2. Tables (301, 302, 303, 304 and 305) and their relationships (306, 307, 308, 309, 310 and 311) are used to retain the data's context as it was discovered in the entire environment (FIG. 1, 112). This data is fed into the correlation process (FIG. 1, 111), discrepancies are noted, weighted, displayed (examples FIGS. 5 and 6) and appropriate alerts are determined by the alert engine (FIG. 1, 113). Examples displayed in FIGS. 4 and 11 are generated along with possible mitigation actions (example FIGS. 6 and 11). Analysis's are then performed by the risk analysis engine (FIG. 1, 111) and displayed in examples FIGS. 7, 9 and 10. Further, escalation possibilities are shown in FIG. 12 as determined by the escalation engine (FIG. 1, 114).

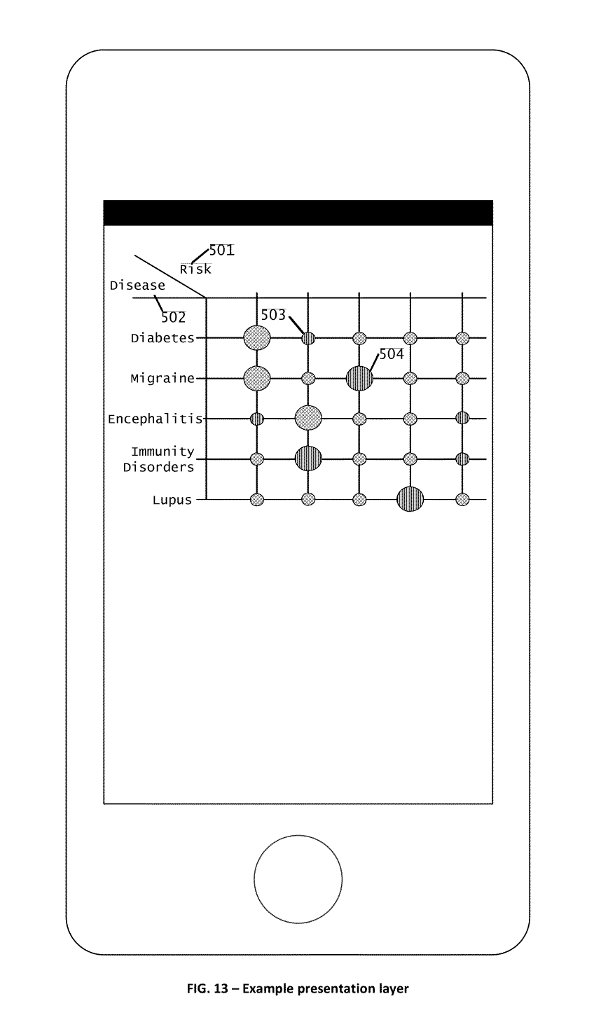

FIG. 13 depicts a sample graphical user interface to allow authorized personnel to interact with the system and the alerts, mitigation steps and data produced by it and depicts a sample forensic analysis generated by the analysis/correlation engine (FIG. 1, 111).

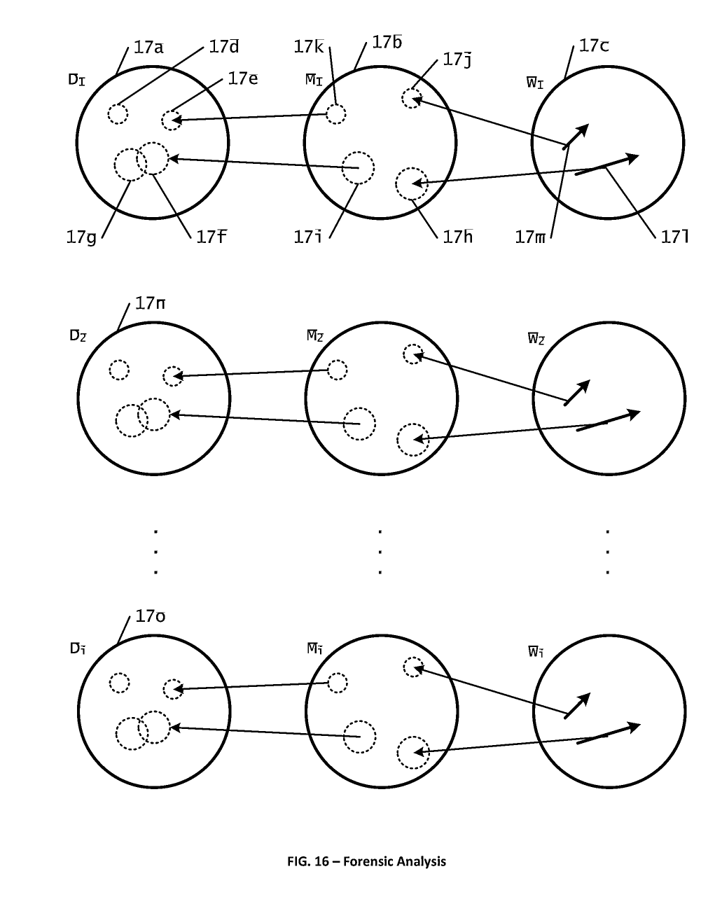

FIG. 16 demonstrates the context for each of three tiers used to deliver the required functionality. 16a shows the area responsible for the presentation, 16b illustrates the logic area and 16c is the area in which data is stored.

FIG. 17 depicts a set theoretical model for forensics which will be explained in the forensics section of this document.

Detection of Device Compromise

Device fingerprinting will determine a unique identifier (FIG. 2) calculated from all the available data (FIG. 2, 202-208) in each device (FIG. 2), this identifier combined with other available attributes of FIG. 1 data sources including the reputation data (FIG. 1, 111) will be combined and hashed to produce unique identifiers. If someone gives the authentication engine a device the authentication engine will understand all of the available and implied data (FIG. 2) in that and related to that device (FIG. 1). For example, network devices typically are identified by services provided, software running, and network address information. The authentication engine will look at each of these data points and use the historic data in combination with real-time analysis (FIG. 1, 111) to produce valid information.

We call this Contextual Meta-data. For example, this data includes characteristics of devices, networks connecting to other networks and routers and utilization of network based services, such as DNS, to enable them communicate. The context of each device (Contextual Meta-data) can be observed and memorialized over time.

The combination of device meta-data fingerprinting and Contextual Meta-data awareness exponentially increase the ability to identify and authenticate devices and can be used in helping detect and understand spoofing and other intrusions.

Device Situational Awareness and Correlation

One embodiment of the present invention allows real-time alerts to be issued based on the real-time and historical meta-data and Contextual Meta-data. In one embodiment of the present invention, the events will be correlated (FIG. 1, 111), both present and historical via the alert engine (FIG. 1, 113) one or more actions in response to the correlation exceeding a particular threshold. As previously described, the correlation process may evaluate various rules, such as “issue an alert to a given destination when data differs over a given period of time.” Various actions may be taken under certain conditions, and may be activated by the alert/action engine when a certain set of conditions are met.

In addition to alerting on the occurrence of primitive or compound events, the present invention may also alert based on an accumulated value of multiple events across space and time. Equations 1 to 3 show possible rules that may be evaluated by the correlation process. For example, as shown in Eq. 1, action component a, will be activated if the expression on the left-hand side is greater than a predetermined threshold, τ₁. In Eqs. 1-3, “a” stands for an action, “w” stands for attribute weights, “x” stands for device accessibility events, and “d” stands for device attribute changes. Eqs. 1-3 could represent a hierarchy of actions that would be activated for different threshold scenarios. Eqs. 1-3 are illustrative of only one embodiment of the present invention, and the present invention may be implemented using other equations and/or other expressions.

$$\begin{matrix}{a}_{1} \text{:} {\sum }_{i = 1}^{i = N} {w}_{i} + {x}_{i} + {\sum }_{i = 1}^{m} {w}_{i} + {d}_{i} \geq {τ}_{1} & ( 1 ) \\ {a}_{2} \text{:} {\sum }_{i = 1}^{i = N} {w}_{i} + {x}_{i} + {\sum }_{i = 1}^{m} {w}_{i} + {d}_{i} \geq {τ}_{2} \\ … & ( 2 ) \\ {a}_{n} \text{:} {\sum }_{i = 1}^{i = N} {w}_{i} + {x}_{i} + {\sum }_{i = 1}^{m} {w}_{i} + {d}_{i} \geq {τ}_{n} & ( 3 )\end{matrix}$$

Equation 4 shows an example of a calculation for determining weights. The weights “wᵢ” may be a weighted average of attribute data (aᵢ), including device accessibility data (R, “Src_AW_Quality”), age of the device accessibility data (A, “Src_AW_Age”), time since last instance of the device access data (TM, “Src_AW_Currency”), and reliability of the source of the device accessibility data (RS, “Src_AW_Reliability”). Note that a similar expression can be used to calculate the importance (Y) of data by the authentication module when determining when to validate a device. Other weighting factors may also be used, and the weighing factors described here are illustrative only and are not intended to limit the scope of the invention.

$${w}_{i} = {\sum }_{k = 0}^{N} {ω}_{k} {a}_{k} \qquad ( 4 )$$

In equation 4, ωₖ are relative weights of the attributes (aₖ), which are themselves weights associated with the data sources. The preceding equations are illustrative of but one manner in which the present invention may be implemented and are not intended to limit the scope to only these expressions.

Historical data may be dynamically organized into a decision tree based on its importance (Y). The data may also be reorganized to “reset”. The importance (Y) may be calculated as a weighted average of the attributes of the reputation data (including attributes of the device used to capture the reputation data). Examples of attributes of the reputation data include, but are not limited to, the following:

The data depicted in FIG. 3.
IP
Entities
Devices
Networks
Entity Detail
DNS
Path History
Device History
Intrusion
Black Lists
Performance
As well as data from all sources in FIG. 1

Importance of the historical data (Y) is used to organize the historical data, and may be calculated as a weighted average, as shown in Equation A.

$$Y = {\sum }_{i = 1}^{i = N} {w}_{i} \cdot {a}_{i} \qquad ( A )$$

where Y=importance of the data, aᵢ=attributes of the data (Σaᵢ=1), wᵢ=relative weights of the attributes (Σwᵢ=1), and N=total number of attributes.

If t₀≦Y≦1 then data is stored in highest (first) hierarchy.

If t₁≦Y≦t₀ to then data is stored in second hierarchy.

If t₂≦Y≦t₁ then data is stored in third hierarchy.

. . .

If 0≦Y≦tₙ then data is stored in lowest (last) hierarchy, where 1>t₀>t₁>t₂> . . . >tₙ>0

For example, in a case of six attributes each weighted equally, the importance Y may be calculated as shown in Equation B:

Y=(L+R+A+RS+TM+TS)/6 (B)

Forensic Analysis

Forensic analysis and event correlation across both space and time may be performed using the database schemas described here according to the principles of the present invention. The events, both primitive and compound, that are recorded in the Entities (FIG. 3, 304) and Entity Detail (FIG. 3, 303) database tables may be used as indices into the meta-data. After the data and meta-data have been stored in these tables, this data may be used to significantly enhance search and retrieval of the data. That is, in order to perform a search of the data, the tables may be searched first, and the data may be used as an index of itself.

For example, suppose an event was recorded in the Entities and EntityDetail tables during detection of a change in a particular device. If at a later time it was desired to locate all places in the data where change was detected, a database query would be performed on these tables to retrieve all events where device changes were noted. The pointers to the data and the indices into the data would provide a mechanism by which to retrieve the data that corresponds to those occurrences.

FIG. 17 shows a possible set-theoretic explanation of the operation of the above historical analysis. Consider the sets of data D₁, D₂, . . . , Dᵢ shown as elements 17a, 17n, and 17o in FIG. 17 respectively. Sets D₁ (element 17a) and D₂ (element 17n) represent data from device 1 and device 2, respectively, and so on. Each set of data Dᵢ has subsets of data, for example, subsets for a particular date range, for a particular time range, for a particular event, etc. For example, set 17a has subsets of data identified as elements 17d, 17e, 17f and 17g in FIG. 17.

Each set of data Dᵢ has a corresponding set of meta-data Mᵢ associated with it. Each element in the set of meta-data Mᵢ has an index, or a pointer, to a corresponding portion of the data Dᵢ. For example, meta-data set M₁, shown as element 17b in FIG. 17, has corresponding subsets of meta-data, shown as elements 17h, 17i, 17j and 17k. Each subset of meta-data is indexed, or points to, a corresponding subset of data. For example, subset 17k of meta-data M₁ is indexed, or points to, subset 17e of data D₁ from device 1 (not shown). Note that a one-to-one relationship between data and meta-data is illustrated in FIG. 17 for clarity. The relationship between data and meta-data is not restricted to being one-to-one. The relationship may be one-to-many, many-to-one, as well as many-to-many.

In addition, sets Wᵢ of attribute weight data are weight vectors associated with each set of meta-data Mᵢ for device i (not shown). The sets W of attribute weight data are sets of vectors W_{i,j} which represent weights associated with subsets of the meta-data Wᵢ. For example, weight vector W_{i,j} represented as element 17m, represents the weights associated with meta-data subset 17j. The weight vectors W_{i,j} may be n-dimensional vectors representing the weights in one of a number of dimensions, each dimension representing a weight in a particular attribute of the data. For example, a 2-dimensional weight [w₁₁, w₁₂] vector may represent the attribute weights associated with the reliability of a particular device for both reliability as well as change detection reliability. One device may have reliability and low change detection reliability, while another device may have high change detection reliability and low reliability. In principle, the attribute weight vectors w_{i,j} may be arbitrarily dynamically fine-tuned with respect to subsets of the meta-data and subsets of the data. In practice, attribute weight vectors w_{i,j} are constant over large subsets of the meta-data and the data, and may have large discontinuities between subsets. For example, change detection may have a very low reliability weight, and very high change detection reliability or vice versa for typical devices.

The set-theoretic described has been shown and described here for ease of understanding and explanation of the present invention. The meta-data and data may or may not be stored as sets; the data may be stored in matrices, tables, relational databases, etc. The set description is shown for clarity only. The present invention is not limited to this particular mathematical representation, and one of ordinary skill will recognize numerous alternative and equivalent mathematical representations of the present invention.

A possible query to retrieve those events in which a person was detected would be:

SELECT*FROM EVENTS WHERE MDParameterID=10 (1)

Query (1) would retrieve all events where a device was detected. In the set-theoretic notation described above, the query (1) would correspond to:

∀xⱼ∈Vᵢ|M_{i,j}(MDParameterID=10) (2)

In order to view the data corresponding to a particular event, a possible follow-on query would be:

VIEW EVENT 1 (3)

Similar queries could be used to retrieve other events. For example, in order to retrieve all reliability events, a possible query would be:

SELECT*FROM EVENTS WHERE MDParameterID=12 (4)

Query (4) would be represented in set-theoretic notation as:

∀xⱼ∈Vᵢ|M_{i,j}(MDParameterID=12) (5)

To view the first 3 events where reliability change was detected, a possible query would be:

VIEW EVENT1,2,3 (6)

Another possible query, to search for all data where a device change was detected, a possible query would be:

SELECT*FROM EVENTS WHERE MDParameterID=11 (7)

Query (7) would be represented in set-theoretic notation as:

∀xⱼ∈Vᵢ|M_{i,j}(MDParameterID=11) (8)

Similarly, in order to view the data corresponding to the first two events where a device change was detected, a possible query would be:

VIEW EVENT1,2 (9)

Event searches may be restricted by particular locations or date-ranges. For example, an analyst may only wish to search a particular device, or location, where change was detected, for example:

SELECT*FROM EVENTS WHERE MDParameterID=6 AND SrcID=1 (10)

Query (10) would be represented in set-theoretic notation by restricting the search to Dᵢ (data from device 1) as follows:

∀xⱼ∈Vᵢ|M_{i,j}(MDParameterID=6∪SrcID−1) (11)

The security analyst may also restrict searches by date and/or time. For example, the security analyst may only wish to search a particular date range where motion was detected, for example:

SELECT*FROM EVENTS WHERE MDParameterID=6 AND MD_Event-DateTime>=09/26/2007 (12)

Query (12) may be represented in set-theoretic notation as:

∀xⱼ∈Vᵢ|{M_{i,j}(MDParameterID=6)∩M_{i,j}(MD_Event_DateTime≧(09-26-2007)) (13)

Multiple events may also be searched. For example, an analyst may want to search historical data for all occurrences where a certain network event was detected. A possible query to accomplish this would be:

SELECT*FROM EVENTS WHERE MDParameterID=10 OR MDParameterID=16 (14)

Query (14) may be represented in set theoretic notation as:

∀xⱼ∈Vᵢ|{M_{i,j}(MDParameterID=10)∪M_{i,j}(MDParameterID=16) (15)

Any number of combinations and sub-combinations of events may be searched using the query language, including unions and intersections (conjunctions and disjunctions) of events using AND/OR operators, as well as other logical operators.

Events may also be correlated and analyzed across multiple devices, or multiple locations. For example, an analyst may want to see all events where change was detected in a particular network, or a data stream was detected in at a certain device. To perform such a search, the security analyst could search by:

SELECT*FROM EVENTS WHERE (MDParameterID=6 AND SrcID=1) OR (MDParameterID=15 AND SrcID=2) (16)

Query (16) may be interpreted in set-theoretic notation as:

∀xⱼ∈D₁∪D₃|{M_{i,j}(MDParameterID=6∪SrcID=1)∩M_{2,j}(MDParameterID=15∪SrcID=2) (17)

The analyst is not required to use a query language. A query language may be used for sophisticated searches. For more basic searches, a user interface is provided for the analyst, which allows the analyst to select the meta-data criteria by which to search by using a visual tool. The user interface automatically generates the query language and queries the database for retrieval.

A possible structured query language was shown here. However, the present invention is not limited to the query language shown or described here. Any number of query languages are within the scope of the present invention, including SQL, IBM BS 12, HQL, EJB-QL, Datalog, etc. The query languages described here is not meant to be an exhaustive list, and are listed here for illustrative purposes only.

When performing queries on meta-data, such as unions and intersections, attribute weights may be recalculated. For example, to recalculate the attribute weights for an intersection of two subsets of meta-data, the attribute weights would be multiplied together, as shown:

W(M₁∩M₂)=W(M₁)·W(M₂) (18)

For example, to calculate the weight associated with two events occurring substantially simultaneously, where the first event has a reliability of 90% (0.90), and the second event has a probability of 50% (0.50), the weight associated with both motion events substantially simultaneously is 45% (0.45).

To recalculate the attribute weights for a union of two subsets of meta-data, the law of addition of probabilities would be applied, as shown:

W(M₁∩M₂)=W(M₁)+W(M₂)−W(M₁)·W(M₂) (19)

For example, to calculate the weight associated with either one of two events occurring substantially simultaneously, where the first event has a reliability of 90% (0.90), and the second event has a probability of 50% (0.50), the weight associated with either one of the events occurring substantially simultaneously is 95% (0.95).

Historical Database Correlation and Alerting

One embodiment of the present invention allows real-time alerts to be issued based on the present and historical data, and especially the present and historical vulnerability events. In one embodiment of the present invention, the correlation process correlates vulnerability events, both present and historical, across multiple devices and multiple locations, and activates via the alert/action engine one or more actions in response to the correlation of the context with other data. As previously described, the correlation process may evaluate various rules, such as “issue an alert to a given destination when a given vulnerability/situation is detected in a given device class/scenario during a designated time.” Security vulnerability detectors are used to detect vulnerability events in the devices, which are then input into the correlation process. Input may also come from other systems, such as logs, real-time path analysis, round-trip-time, time to live, accessibility, law enforcement and police records, blacklists. Various actions may be taken under certain conditions, and may be activated by the alert/action engine when a certain set of conditions are met.

In addition to alerting on the occurrence of primitive or compound events, the present invention may also alert based on an accumulated value of multiple events across space and time. Equations 1 to 3 show possible rules that may be evaluated by the correlation engine. For example, as shown in Eq. 1, action component a₁ will be activated if the expression on the left-hand side is greater than a predetermined threshold, τ₁. In Eqs. 1-3, “a” stands for an action, “w” stands for attribute weights, “x” stands for one class of vulnerability events, and “v” stands for another class of vulnerability events. Eqs. 1-3 could represent a hierarchy of actions that would be activated for different threshold scenarios. Eqs. 1-3 are illustrative of only one embodiment of the present invention, and the present invention may be implemented using other equations and other expressions.

Implementation

FIG. 16 depicts a three-tier Architecture. This architecture separates the presentation from the logic and logic from the data. This allows for much greater scalability and allows for changes to be made in one tier without affecting the other tier. The tiers are as follows: one (16a) the presentation tier; which consists of the methods and context for presentation of data to humans. Typically the presentation tier can be characterized by the graphical user interface as demonstrated on a handheld device such as an Apple iPhone, other smartphones and/or web browser based interfaces. Additionally an important attribute of the presentation tier is the attention paid to the target audience. For example, a Chief Financial Officer may need different data presented in a different format as compared to a law enforcement officer. Two (16b), the logic tier allows the data (16c) to be contextualized (correlated) and for analysis to occur. The logic tier may also be used to exercise forensic analysis on the data store in the date tier. Three (16c), the data tier is responsible for the storage and accessibility of all data. The data tier may also be responsible for some data reduction depending on the specific goals of the system.

Real World Scenarios

See examples in BACKGROUND OF INVENTION. Each one of these intrusions can be mitigated with the inventions presented here.

Alternative Embodiments

FIG. 16 can also be implemented as a hardware embodiment.

What is claimed is:

1. A situational awareness detection and alerting system comprising:
One or more IP Devices
One or more IP Networks
One or more Devices
One or more Networks
One or more DNS servers
One or more routers
One or more firewalls
One or more switches
One or more databases
One or more network access providers
A historical database of previous situations and vulnerabilities in the internet portion of the cloud and how.
A reputation engine—A method of hashing unique identification of devices
An alert engine
An escalation engine
Which will allow one or more actions based on the analysis and decision capabilities of all of the above to put a weighting on the authenticity of who is accessing the cloud and internet.
one or more devices comprising an network;
one or more processors, operatively coupled to the one or more sensors; and
one or more memories, operatively coupled to the one or more processors, the one
or more memories comprising program code which when executed causes the one or more processors to:
a. monitor the one or more devices on the network;
b. detect one or more primitive vulnerability events in the devices;
c. generate attribute data representing information about the importance of the devices;
d. correlate two or more primitive vulnerability events, the primitive vulnerability events weighted by the attribute data of the devices; and
e. perform one or more actions based on the correlation performed in the correlating step.

2. The system of claim 1, further comprising program code to:
receive tip data from one or more sources;
determine attribute data for the tip data, the attribute data representing the reliability of a source of the tip data; and
generate tip events based on the tip data and the attribute data.

3. The system of claim 1, wherein one or more devices.

4. The system of claim 1, further comprising program code to:
monitor network status of the devices; and
generate network events reflective of the network status of the devices.

5. The system of claim 1, wherein the program code to generate attribute data representing information about the importance of the devices further comprises program code to:
determine one or more weights for the primitive vulnerability events based at least on the reliability of the devices.

6. The system of claim 1, further comprising program code to:
determine one or more weights using a weight corresponding to a time when the primitive vulnerability event was received and a weight corresponding to a frequency that the primitive vulnerability event was received.

7. The system of claim 1, further comprising program code to:
determine one or more weights by using a weight based on events external to the devices.

8. A vulnerability detection and alerting system for detecting compromise of one or more devices on a network, the system comprising:
a detector adapted to detect one or more primitive vulnerability events in the devices;
an attribute engine adapted to generate attribute data representing information about the importance of the devices;
a correlation engine adapted to correlate two or more primitive vulnerability events weighted by the attribute data of the devices; and an action engine adapted to perform one or more actions based on the correlation performed by the correlation engine.

9. The system of claim 8, further comprising a normalization engine adapted to normalize the primitive vulnerability events.

10. The system of claim 8, further comprising a filter adapted to filter out primitive vulnerability events based on a set of rules.

11. The system of claim 8, further comprising a compound event detector adapted to detect compound events composed of two or more primitive vulnerability events.

12. The system of claim 8, further comprising:
a time correlator adapted to correlate the primitive vulnerability events and the compound events across time;
a space correlator adapted to correlate the primitive vulnerability events and the compound events across space; and
a rules engine adapted to evaluate one or more rules based on the correlation performed by the time correlator and the space correlator.

13. The system of claim 8, further comprising a learning engine adapted to generate one or more new rules based on the primitive vulnerability events correlated by the correlating process and the actions performed by the action engine.

14. The system of claim 8, wherein the one or more devices are surveillance cameras.

15. The system of claim 8, wherein the attribute data representing information about the importance of the devices is determined based at least on the reliability of the devices.

16. The system of claim 8, wherein the attribute data representing information about the importance of the devices is determined by using a weight corresponding to a time the primitive vulnerability event was received and a weight corresponding to a frequency that the primitive vulnerability event was received.

17. The system of claim 8, wherein the attribute data representing information about the importance of the devices is determined by using a weight based on events external to the devices.

18. A method for detecting vulnerabilities in networks having one or more devices, the method comprising the steps of:
monitoring the one or more devices on the network;
detecting one or more primitive vulnerability events in the devices;
generating attribute data representing information about the importance of the devices;
correlating two or more primitive vulnerability events, the primitive vulnerability events weighted by the attribute data of the devices; and
performing one or more actions based on the correlation performed in the
correlating step.

19. The method of claim 18, further comprising normalizing the primitive vulnerability events.

20. The method of claim 18, further comprising:
filtering out primitive vulnerability events based on a set of rules.

21. The method of claim 18, further comprising:
detecting compound events composed of two or more primitive vulnerability events.

22. The method of claim 18, further comprising:
time correlating the primitive vulnerability events and the compound events
across time;
space correlating the primitive vulnerability events and the compound events
across space; and
evaluating one or more rules based on the correlation performed in the time
correlating step and the space correlating step.

23. The method of claim 18, further comprising:
generating one or more new rules based on the primitive vulnerability events correlated in the correlating step and the actions performed in the action step.
monitoring the one or more devices on the network;
detecting one or more primitive vulnerability events in the devices;
generating attribute data representing information about the importance of the IP
devices;
correlating two or more primitive vulnerability events, the primitive vulnerability
events weighted by the attribute data of the devices; and
performing one or more actions based on the correlation performed in the
correlating step.

24. The method of claim 18, further comprising:
normalizing the primitive vulnerability events.

25. The method of claim 18, further comprising:
filtering out primitive vulnerability events based on a set of rules.

26. The method of claim 18, further comprising:
detecting compound events composed of two or more primitive vulnerability events.

27. The method of claim 18, further comprising:
time correlating the primitive vulnerability events and the compound events
across time;
space correlating the primitive vulnerability events and the compound events
across space; and
evaluating one or more rules based on the correlation performed in the time
correlating step and the space correlating step.

28. The method of claim 18, further comprising:
generating one or more new rules based on the primitive vulnerability events
correlated in the correlating step and the actions performed in the action step.

29. The method of claim 18, further comprising:
receiving tip data from one or more external sources;
determining attribute data for the tip data, the attribute data representing the
reliability of a source of the tip data; and
generating tip events based on the tip data and the attribute data.

30. The method of claim 18, wherein the one or more devices connected.

31. The method of claim 18, further comprising:
monitoring DNS status of the devices; and
generating network events reflective of the network status of the devices.

32. The method of claim 18, wherein the step of generating attribute data representing information about the importance of the all devices on the internet further comprises the step of:
determining one or more weights for the primitive vulnerability events based at least on the reliability of the all devices.

33. The method of claim 18, further comprising:
determining attribute data by using a weight corresponding to a time the primitive vulnerability event was received and a weight corresponding to a frequency that the primitive vulnerability event was received.

34. The method of claim 18, further comprising:
determining attribute data by using a weight based on events external to the devices, data, paths.

35. A method of detecting and alerting on possible network compromise, comprising the steps of: 27. The method of claim 18, further comprising:
receiving tip data from one or more external sources;
determining attribute data for the tip data, the attribute data representing the reliability of a source of the tip data; and
generating tip events based on the tip data and the attribute data.
detecting at least one potential denial of service attack as a first set of vulnerability events;
detecting at least one potential unauthorized usage attempt as a second set of vulnerability events;
detecting at least one potential spoofing attack as a third set of vulnerability events;
detecting at least one compromise of a DNS server;
detecting at least one blacklist listing;
detecting at least one user that authorities identified;
detecting at least one improper time interval for DNS records;
detecting at least one non-matching mail server;
detecting at least one unreachable internet device based on DNS advertising;
correlating the first set of vulnerability event, the second set of vulnerability event, and the third set of vulnerability events; and
sending one or more alerts based on the correlation performed in the correlating step.

36. The method of claim 35, wherein the denial of service attack is detected by a service survey.

37. The method of claim 35, wherein the denial of service attack is detected by a historical benchmark analysis.

38. The method of claim 30, wherein the denial of service attack is detected by a traceroute.

39. The method of claim 30, wherein the unauthorized usage is detected by a passive DNS query.

40. The method of claim 35, wherein the unauthorized usage is detected by log analysis.

41. The method of claim 35, wherein the unauthorized usage is detected by correlations of unusual behavior.

42. The method of claim 35, wherein the spoofing attack is detected by a fingerprint of a device's HTTP server.

43. The method of claim 35, wherein the spoofing attack is detected by a fingerprint of the device's TCP/IP stack.

44. The method of claim 35, wherein the spoofing attack is detected by a fingerprint of the device's configuration settings.

45. The method of claim 35, wherein the spoofing attack is detected by a watermark in a data stream of the device.

46. The method of claim 35, wherein the spoofing attack is detected by burning a unique private key in the device's physical memory.

47. A system for detecting and alerting on possible compromise of an network having one or more devices, the system comprising:
a vulnerability detection engine for detecting one or more vulnerabilities in the network;
a correlation and analysis process adapted to correlate two or more vulnerabilities weighted by
an importance of the device; and
an action engine adapted to perform one or more actions based on the correlation
performed by the correlation and analysis process.

48. The system of claim 47, wherein the denial of service attack is detected by a service survey.

49. The system of claim 47, wherein the vulnerability is detected by a historical benchmark analysis.

50. The system of claim 47, wherein the vulnerability is detected by a traceroute.

51. The system of claim 47, wherein the vulnerability detection engine comprises:
means for detecting at least one potential unauthorized usage attempt.

52. The system of claim 47, wherein the spoofing attack is detected by a fingerprint of the device's HTTP server.

53. The system of claim 47, wherein the spoofing attack is detected by a fingerprint of the device's TCP/IP stack.

54. The system of claim 47, wherein the spoofing attack is detected by a fingerprint of the device's configuration settings.

55. The method of claim 47, wherein the spoofing attack is detected by a watermark in a data stream of the device.

56. The method of claim 47, wherein the spoofing attack is detected by burning a unique private key in the device's physical memory.

57. The system of claim 47, wherein the correlation analysis process comprises:
a normalization engine adapted to normalize the primitive vulnerability events;
a filter adapted to filter out primitive events based on a set of rules;
a compound event detector adapted to detect compound events composed of two
or more primitive vulnerability events;
a time correlator adapted to correlate the primitive vulnerability events and the
compound events across time;
a space correlator adapted to correlate the primitive vulnerability events and the
compound events across space; and
a rules engine adapted to evaluate one or more rules based on the correlation
performed by the time correlator and the space correlator.

58. The system of claims 1 thru 57, for reporting the results in written form.

59. The system of claims 1 thru 58, for reporting the results in a dashboard.

60. The system of claims 1 thru 58 further comprising of program code for implementation in a three-tier architecture: presentation, analytics and data.
